(19) United States
(12) Patent Application Publication
(10) Pub. No.: US 2007/0052629 A1
(43) Pub. Date: Mar. 8, 2007

(54) Plasma display apparatus

(75) Inventors: Seonghak Moon, Seoul (KR); Sung Soo Hong, Goyang-si (KR); Taehyung Kim, Seoul (KR); Chung-Wook Roh, Seoul (KR); Byung Goo Kong, Yongin-si (KR); Byeong Kil Ahn, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/516,749

(22) Filed: Sep. 7, 2006

(30) Foreign Application Priority Data
Sep. 8, 2005 (KR) 10-2005-0083862

(51) Int. Cl. G09G 3/28

(52) U.S. Cl. 345/68

(57) ABSTRACT

A plasma display apparatus comprises a plasma display panel that comprises an electrode; a sustain driver that supplies a sustain signal to the electrode and that comprises a first and second switching elements for supplying the sustain signal; and a first and second gate drivers that drives each of the first and second switching elements, wherein the first gate driver receives a driving voltage for driving the first switching element from a driving voltage source of the first gate driver, the second gate driver comprises a driving voltage source that supplies a driving voltage for driving the second switching element, and an auxiliary voltage for assisting the driving voltage is supplied from the outside of the second gate driver so that the second switching element is driven by the driving voltage.

This Nonprovisional application claims priority under 35 U.S.C. § 119(a) on Patent Application No. 10-2005-0083862 filed in Korea on Sep. 8, 2005 the entire contents of which are hereby incorporated by reference.

### BACKGROUND

1. Field

This document relates to a plasma display apparatus.

2. Description of the Background Art

In general, in a plasma display apparatus, a plasma display panel for displaying an image and a driver for driving the plasma display panel are attached to a rear surface of the plasma display panel.

The plasma display panel comprises a plurality of discharge cells formed with a barrier rib between a front substrate and a rear substrate of the plasma display panel for displaying an image. An inert gas containing a main discharge gas such as neon (Ne), helium (He), or a mixed gas (Ne+He) of neon and helium and a small quantity of xenon is charged within each cell. A plurality of discharge cells constitutes one pixel. For example, a red color (R) discharge cell, a green color (G) discharge cell, and a blue color (B) discharge cell constitute one pixel.

The driver supplies a driving signal having various functions for driving the plasma display panel.

A sustain driver among the drivers supplies a high voltage of sustain signal so as to maintain a discharge within each discharge cell.

Switching elements of the sustain driver compose switching elements for controlling a high voltage so that the sustain driver controls and supplies a sustain signal comprising the high voltage.

As switching elements of the sustain driver are not directly controlled by a low voltage of control signal that is supplied from a controller but controlled by a gate drive as a control signal is supplied to the gate driver for controlling a gate terminal of the switching elements in the sustain driver.

In the relater art, gate driver circuits for controlling each of switching elements MH and ML were electrically connected to each of the switching elements MH and ML of the sustain driver.

Each of the switching elements MH and ML was tuned on if the gate terminal G is higher by 5 to 15V than a source terminal S and was turned off if the gate terminal G is lower by 5 to 15V than the source terminal S.

Gate driver circuits for controlling each of the switching elements MH and ML were referred to as a boot-strap type circuit.

The boot-strap type circuit turned on or turned off the switching elements MH and ML for selectively supplying an applied voltage Vs and a ground voltage GND to an output terminal Vout using control signals HI and LI. A boot-strap circuit connected to FET switching elements means a circuit for supplying a voltage higher by 5 to 15V than the source terminal S to the gate terminal G of each of the switching elements MH and ML using charge capacitors CH and CL.

When there were one switching element ML for supplying a ground voltage of a sustain signal and one switching element MH for supplying a sustain voltage of a sustain signal, a voltage for turning on the switch ML had a voltage difference of about 15V between the gate terminal G and the source terminal S.

Therefore, after charging a driving voltage to the charge capacitor CL using a 15V power source P depending on a first current pass, a gate driver supplied a voltage charged to the charge capacitor CL to a gate terminal of the switching element ML by operating so that a terminal Vcc and a terminal LO were connected to each other by a control signal supplied to the line LI, whereby a voltage difference of 15V was generated between the gate terminal and the source terminal and thus the switch ML was turned on.

Furthermore, the gate driver turned off the switch ML by a control signal for connecting the terminal LO and a terminal COM to each other.

The gate driver also turned on the switch MH by generating a voltage difference of 15V between the gate terminal and the source terminal through supplying a driving voltage to the gate terminal of the switch MH.

Here, a voltage of 15V should be charged to the charge capacitor CH so as to generate a voltage difference of 15V between the gate terminal and the source terminal of the switch MH.

The switch ML should be turned on so as to charge the charge capacitor CH. This is because a second current pass for charging a voltage of a 15V constant voltage source to the capacitor CH was formed.

Specifically, a current pass was formed at a time point when an output voltage Vout becomes a ground level voltage as the switch ML was turned on and thus a voltage of 15V power source P was charged to the charge capacitor CH through a diode D, whereby a driving voltage of the switch MH was formed.

Thereafter, as the charge capacitor CH was charged, a terminal Vb and a terminal HO of the gate driver were connected to each other by a control signal supplied to the line HI and thus a driving voltage of the switch MH generated a voltage difference of 15V between the gate terminal and the source terminal by supplying a voltage charged to the charge capacitor CH to the gate terminal of the switch MH, thereby tuning on the switch MH.

Furthermore, the gate driver turned off the switch MH by a control signal for connecting the terminal HO and a terminal Vb to each other.

A circuit such as the gate driver was referred to as a boot-strap type circuit and a circuit for receiving a driving voltage from a voltage source of other gate drivers as in the gate driver was referred to as a boot-strap chain type circuit.

When the sustain driver supplied only a positive sustain voltage with a sustain signal, it was easy to apply a boot-strap circuit or a boot-strap chain circuit as a circuit for driving a switch of the sustain driver.

However, when the sustain driver supplied various level of voltages such as a half 2/Vs of a positive sustain voltage and a positive sustain voltage Vs with a sustain signal, there was a problem that the sustain driver could be not controlled with only the boot-strap circuit and the boot-strap chain circuit

This is because a current pass was formed in only a case where one end of the charge capacitor CH was connected to a ground voltage level GND as the switch ML of the sustain driver was turned on in the gate driver, which is the boot-strap chain circuit and thus a voltage of the 15V power source P could be supplied to the charge capacitor CH.

In this case, there was a problem that a floating power source having large bulk and power consumption should be used as a voltage source for charging to a charge capacitor.

In order to physically embody the floating power source, a power source of a relatively large area was required, a circuit construction become complicated, and relatively expensive elements were required, whereby a manufacturing cost increased.

### SUMMARY

An object of an implementation of a plasma display apparatus is to provide a plasma display apparatus that can simplify a circuit of a gate driver and reduce a manufacturing cost by using not a floating power source but a ground power source in a gate driver for controlling switching elements of a sustain driver.

In an aspect, a plasma display apparatus comprising: a plasma display panel that comprises an electrode; a sustain driver that supplies a sustain signal to the electrode and that comprises a first and second switching elements for supplying the sustain signal; and a first and second gate drivers that drives each of the first and second switching elements, wherein the first gate driver receives a driving voltage for driving the first switching element from a driving voltage source of the first gate driver, the second gate driver comprises a driving voltage source that supplies a driving voltage for driving the second switching element, and an auxiliary voltage for assisting the driving voltage is supplied from the outside of the second gate driver so that the second switching element is driven by the driving voltage.

In another aspect, a plasma display apparatus comprising: a plasma display panel that comprises an electrode; a sustain driver that supplies a sustain signal to the electrode and that comprises a first, second, and third switching elements for supplying the sustain signal; and a first, second, and third gate drivers that drive each of the first, second, and third switching elements, wherein the first gate driver receives a driving voltage for driving the first switching element from a driving voltage source of the first gate driver, the second gate driver comprises a driving voltage source that supplies a driving voltage for driving the second switching element and an auxiliary voltage for assisting the driving voltage is supplied from the outside of the second gate driver so that the second switching element is driven by the driving voltage, and the third gate driver receives a driving voltage for driving the third switching element from other gate drivers.

Further features will be apparent from the following description, including the drawings, and the claims.

### BRIEF DESCRIPTION OF THE DRAWINGS

The embodiment of the invention will be described in detail with reference to the following drawings in which like numerals refer to like elements.

FIG. 1 is a view illustrating a general sustain driver and gate driver,

FIG. 2 is a view illustrating an implementation of a plasma display apparatus;

FIG. 3 is a view illustrating an implementation of a structure of a plasma display panel shown in FIG. 2;

FIG. 4 is a view illustrating an implementation of a method of driving the plasma display panel;

FIG. 5 is a view illustrating a gate driver and a sustain driver for supplying a sustain signal shown in FIG. 4;

FIG. 6A is a view illustrating a method of operating a second gate driver shown in FIG. 5;

FIG. 6B is a view illustrating a method of operating a third gate driver shown in FIG. 5;

FIG. 7 is a view illustrating the output sustain signal and a switching timing chart of a sustain driver shown in FIG. 5;

FIGS. 8A to 8H are views illustrating a method of driving the sustain driver depending on switching timing shown in FIG. 7.

### DETAILED DESCRIPTION

Embodiments of the present invention will be described in a more detailed manner with reference to the drawings.

In an aspect, a plasma display apparatus comprising: a plasma display panel that comprises an electrode; a sustain driver that supplies a sustain signal to the electrode and that comprises a first and second switching elements for supplying the sustain signal; and a first and second gate drivers that drives each of the first and second switching elements, wherein the first gate driver receives a driving voltage for driving the first switching element from a driving voltage source of the first gate driver, the second gate driver comprises a driving voltage source that supplies a driving voltage for driving the second switching element, and an auxiliary voltage for assisting the driving voltage is supplied from the outside of the second gate driver so that the second switching element is driven by the driving voltage.

The second gate driver may receive the auxiliary voltage from a capacitor of the sustain driver.

The auxiliary voltage may be formed by receiving a voltage from a capacitor of the sustain driver and charging the voltage to an auxiliary charge capacitor that is connected in series to a gate terminal of the second switching element.

Each resistance may be connected in series to both ends of the auxiliary charge capacitor and the each resistance may be connected in series to the capacitor of the sustain driver.

The sustain driver may supply a signal rising from a first voltage to a second voltage through resonance and rising from the second voltage to a third voltage through resonance to the electrode.

The sustain driver may supply a sustain signal rising from the first voltage to the second voltage through resonance and then maintaining the second voltage during a predetermined period to the electrode.

The first voltage may be substantially a ground level voltage GND.

The third voltage may be substantially a sustain voltage.

The second voltage may be substantially a half of a sustain voltage.

The electrode may be a sustain electrode or a scan electrode.

In another aspect, a plasma display apparatus comprising: a plasma display panel that comprises an electrode; a sustain driver that supplies a sustain signal to the electrode and that comprises a first, second, and third switching elements for supplying the sustain signal; and a first second, and third gate drivers that drive each of the first, second, and third switching elements, wherein the first gate driver receives a driving voltage for driving the first switching element from a driving voltage source of the first gate driver, the second gate driver comprises a driving voltage source that supplies a driving voltage for driving the second switching element and an auxiliary voltage for assisting the driving voltage is supplied from the outside of the second gate driver so that the second switching element is driven by the driving voltage, and the third gate driver receives a driving voltage for driving the third switching element from other gate drivers.

The second gate driver may receive an auxiliary voltage from a capacitor of the sustain driver.

The auxiliary voltage may be formed by receiving a voltage from the capacitor of the sustain driver and charging the voltage to the auxiliary charge capacitor that is connected in series to a gate terminal of the second switching element.

Each resistance may be connected in series to both ends of the auxiliary charge capacitor and the each resistance may be connected in series to the capacitor of the sustain driver.

The third gate driver may receive a driving voltage of the third gate driver from the first gate driver.

The driving voltage may be supplied from the first gate driver to the third gate driver while the first switching element is turned on.

The driving voltage may be formed by receiving a voltage from a charge capacitor of the first gate driver and charging the voltage to a charge capacitor comprised in the third gate driver.

The plasma display apparatus may further comprise a diode between the charge capacitor of the third gate driver and the charge capacitor of the first gate driver.

A cathode of the diode may be electrically connected to the charge capacitor of the third gate driver and an anode of the diode may be electrically connected to the charge capacitor of the first gate driver.

The sustain driver may supply a signal rising from a ground level of voltage to a half of a sustain voltage through resonance and rising from the half of the sustain voltage to a sustain voltage through resonance to the electrode.

Hereinafter, exemplary implementations will be described in detail with reference to the attached drawings.

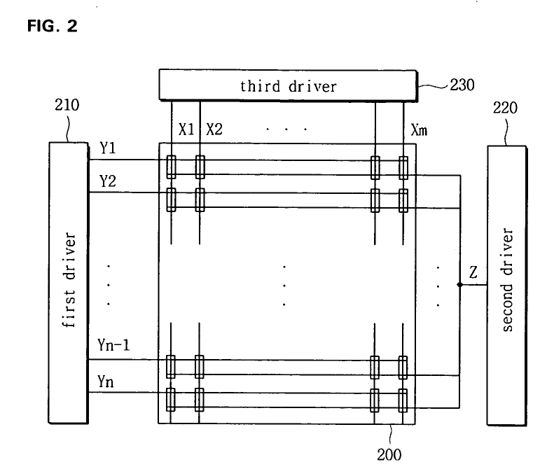

FIG. 2 is a view illustrating an implementation of a plasma display apparatus.

As described above, an implementation of the plasma display apparatus comprises a plasma display panel 200, a first driver 210, a second driver 220, and a third driver 230.

The first driver 210 and the second driver 220 comprise a sustain driver, and the third driver 230 comprises a data driver.

The first driver 210 drives first electrodes Y1 to Yn of the plasma display panel 200.

The first driver 210 comprises the sustain driver and the sustain driver can supply a multi level of sustain signal to the first electrodes Y1 to Yn during a sustain period so that an image is displayed by maintaining a discharge.

For example, a multi level of sustain signal can comprise a half of a positive sustain voltage and a positive sustain voltage.

The sustain driver comprises a plurality of switching elements for controlling a sustain signal and the plurality of switching elements is controlled by a gate driver.

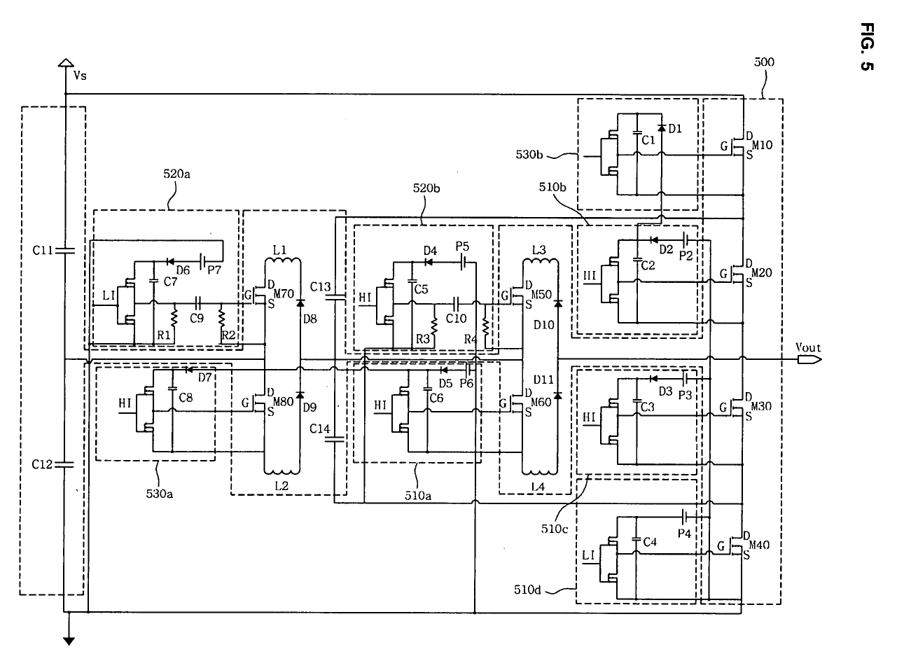

The gate driver comprises at least two types of gate drivers. The gate driver will be described with reference to FIGS. 5 to 8.

Furthermore, the first driver 210 can supply a reset signal in a reset period and a scan reference voltage and a scan signal in an address period to the first electrodes Y1 to Yn so that wall charges are uniformly formed within a discharge cell.

The second driver 220 drives a second electrode Z of the plasma display panel 200.

The second driver 220 comprises a sustain driver and the sustain driver can supply a multi level of sustain signal in a sustain period.

The third driver 230 comprises a data driver, and the data driver supplies a data signal to the third electrodes X1 to Xm formed in the plasma display panel 200 in an address period.

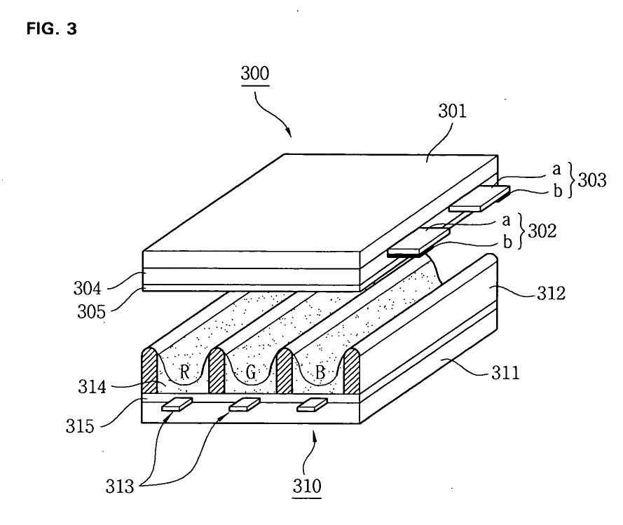

FIG. 3 is a view illustrating an implementation of a structure of a plasma display panel shown in FIG. 2.

Referring to FIG. 3, in the plasma display panel 200, a front panel 300 and a rear panel 310 are coupled in parallel to each other and apart a predetermined of distance. In the front panel 300, a first electrode 302 (Y) and a second electrode 303 (Z) for maintaining a discharge are formed in a front substrate 301, which is a display surface for displaying an image. In the rear panel 310, a plurality of third electrodes 313 (X) is arranged so that the first electrode 302 (Y) and the second electrode 303 (Z) intersect on the rear substrate 311 forming a rear surface.

The front panel 300 comprises the first electrode 302 (Y) and the second electrode 303 (Z) for performing a mutual discharge and maintaining emission of a discharge cell in one discharge space, i.e., a discharge cell. In a sustain electrode, the first electrode 302 (Y) and the second electrode 303 (Z) comprising a transparent electrode (a) that is made of a transparent ITO material and a bus electrode (b) that is made of a metal material can be formed in pairs. The first electrode 302 (Y) and the second electrode 303 (Z) are covered with at least one upper dielectric layer 304 that limits a discharge current and that isolates between electrode pairs. In an upper surface of the upper dielectric layer 304, a protective layer 305 deposited with magnesium oxide (MgO) can be formed so as to facilitate a discharge condition.

In the rear panel 310, stripe type (or well type) barrier ribs 312 for forming a plurality of discharge spaces, i.e., discharge cells can be arranged in parallel. Furthermore, a plurality of third electrodes 313 (X) for generating vacuum ultraviolet rays by performing an address discharge can be disposed in parallel to the barrier rib 312. R, G, and B phosphors 314 that emit visible rays for displaying an image upon an address discharge are coated in the upper side surface of the rear panel 310. A lower dielectric layer 315 for protecting the third electrode 313 (X) can be formed between the third electrode 313 (X) and the phosphor 314.

FIG. 3 shows only an implementation of the plasma display panel 200, where the panel is not limited to such a structure.

For example, FIG. 3 shows that the first electrode 302 (Y) and the second electrode 303 (Z), which are a sustain electrode, comprise transparent electrodes 302a and 303a and bus electrodes 302b and 303b, respectively, but at least one of the first electrode 302 (Y) and the second electrode 303 (Z) may comprise only the bus electrodes 302b and 303b.

For example, FIG. 3 shows that the upper dielectric layer 304 has a uniform thickness, but the upper dielectric layer 304 may have a different thickness and dielectric constant for each area, and FIG. 3 shows only a barrier rib 312 having a fixed space, but in order to match white balance, a space of the barrier rib 312 in a discharge cell B can be more extensively formed.

Furthermore, by forming a side surface of the barrier rib 312 in an unevenness shape and a coated phosphor layer 314 depending on an unevenness shape, brightness of an image embodied in the plasma display panel 200 may be increased.

Furthermore, in a manufacturing process of the plasma display panel, a tunnel may be formed in a side surface of the barrier rib 312 in order to improve exhaust characteristics.

Next, an implementation of a driving method in which each of drivers 210, 220, and 230 shown in FIG. 2 drives a plurality of electrodes of the plasma display panel 200 will be described in detail with reference to FIG. 3.

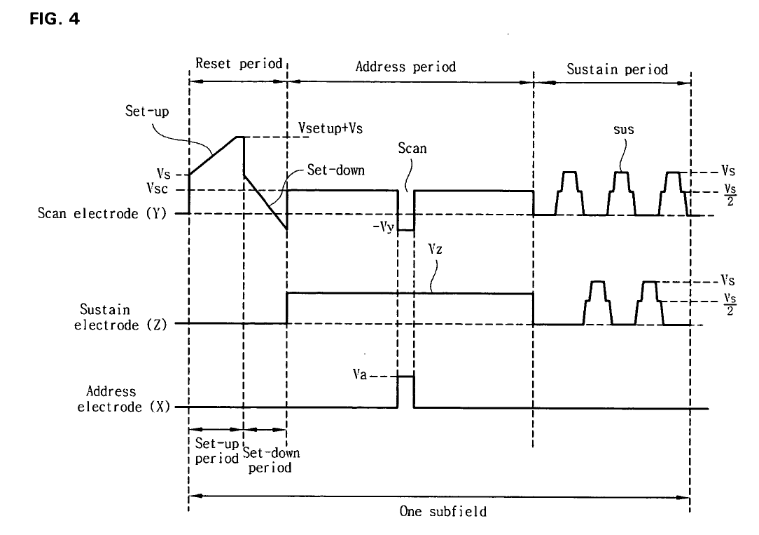

FIG. 4 is a view illustrating an implementation of a method of driving the plasma display panel.

As shown in FIG. 4, each of the drivers 210, 220, and 230 shown in FIG. 2 supplies a driving signal to the first electrode Y, the second electrode Z, and the third electrode X during a reset period, an address period, and a sustain period.

The first driver 210 can supply the same set-up signal as that shown in the first electrode Y in a set-up period of a reset period.

A weak dark discharge is generated within a discharge cell of an entire screen by the set-up signal. Positive wall charges are stacked on the second electrode Z and the third electrode X by the set-up discharge and negative wall charges are stacked on the first electrode Y.

Furthermore, after a set-up signal is supplied to the first electrode Y in a set-down period, the first driver 210 can supply a set-down signal falling from a positive voltage lower than a highest voltage of a set-up signal to a specific voltage level lower than a ground GND level of voltage. Accordingly, a feeble erase discharge generates within the discharge cell, whereby wall charges excessively formed within the discharge cell are fully erased. Wall charges of the extent of stably generating an address discharge by the set-down discharge uniformly remain within the discharge cell.

FIG. 3 illustrates a case where both a set-up signal and a set-down signal are supplied in a reset period, but at least one of the set-up signal and the set-down signal may allow a ground level of voltage to be maintained and the set-up signal may be a signal of maintaining the same level of voltage as a positive sustain voltage during a set-up period.

Furthermore, the first driver 210 supplies a scan reference voltage Vsc to the first electrode in an address period, and the first driver 210 can supply a scan signal Scan falling from a scan reference voltage Vsc to a negative voltage (−Vy) to the first electrode Y at a time point when a data signal Va supplied by the third driver 230 is supplied to the third electrode during an address period.

As a voltage difference between the scan signal Scan and the data signal Va and a wall voltage generated during a reset period are added, an address discharge is generated within a discharge cell to which a data signal Va is supplied.

Wall charges of the extent of generating a discharge when a sustain voltage Vs is applied are generated within a discharge cell selected by an address discharge. Accordingly, the first electrode Y is scanned.

FIG. 4 shows as an implementation that the first driver 210 supplies a scan reference voltage Vsc to the first electrode Y during an address period, but a scan bias voltage (−Vy+Vsc) may be supplied instead of the scan reference voltage Vsc.

A sustain driver comprised in the first driver 110 and a sustain driver comprised in the second driver 120 can alternately supply a sustain signal to the first electrode Y and the second electrode Z in a sustain period.

As shown in FIG. 4, the sustain signal comprises various voltages such as a half Vs/2 of a positive sustain voltage and a positive sustain voltage Vs.

Furthermore, a part or all of a sustain signal that is alternately supplied to the first electrode Y and the second electrode Z can be supplied to be overlapped.

According to a sustain signal supplied during a sustain period, whenever every sustain signal SUS is applied while a wall voltage within the discharge cell and a sustain signal SUS are added in a discharge cell selected by an address discharge, sustain discharge, a sustain discharge, i.e., a display discharge is generated between the first electrode Y and the second electrode Z.

An erase period may be further added in a driving method described according to an implementation.

FIG. 5 is a view illustrating a gate driver and a sustain driver for supplying a sustain signal shown in FIG. 4.

As shown in FIG. 5, a sustain driver 500 for supplying a sustain signal comprises first switching elements M20, M30, M40, and M60, second switching elements M50 and M70, third switching elements M10 and M80, a plurality of inductors L1 to L4, and a plurality of capacitors C₁₁ to C₁₄.

The sustain driver 500 can supply a multi voltage level of sustain signal comprising a half Vs/2 of a positive sustain voltage and a positive sustain voltage Vs.

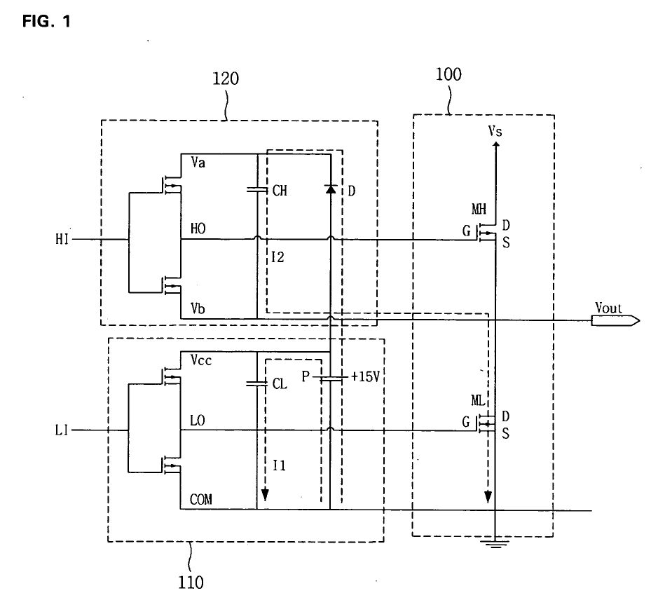

Furthermore, the sustain driver 500 can be comprised in at least one of the first driver and the second driver shown in FIG. 1.

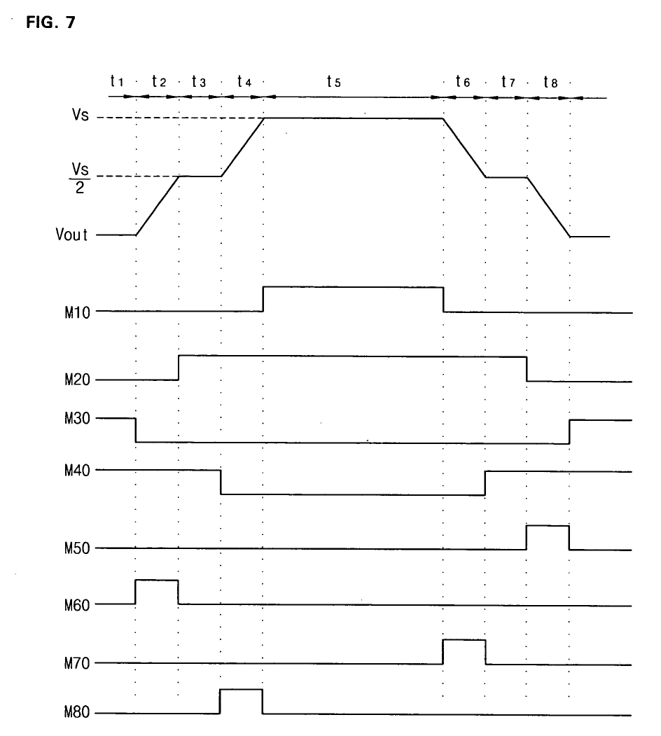

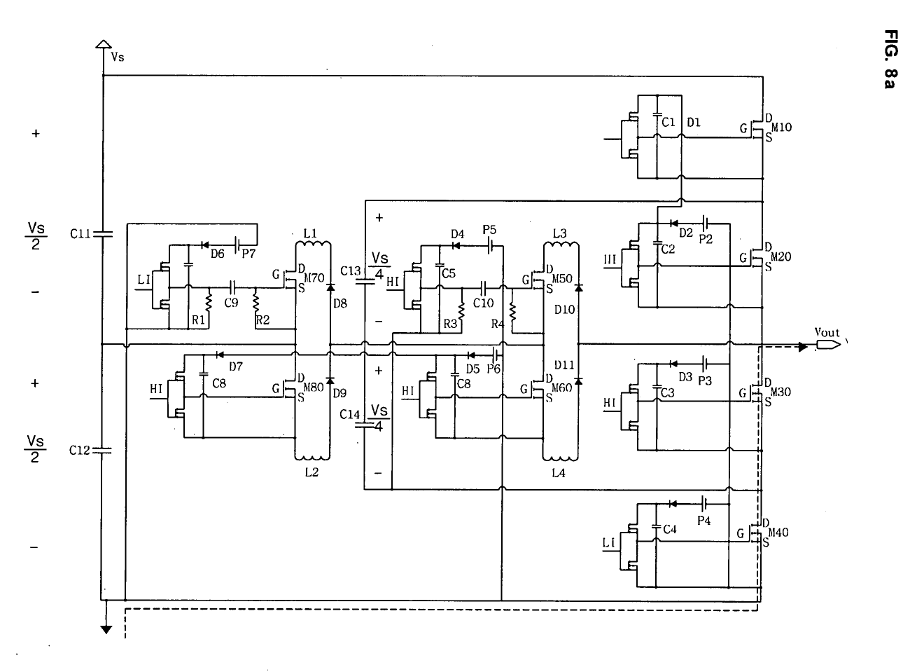

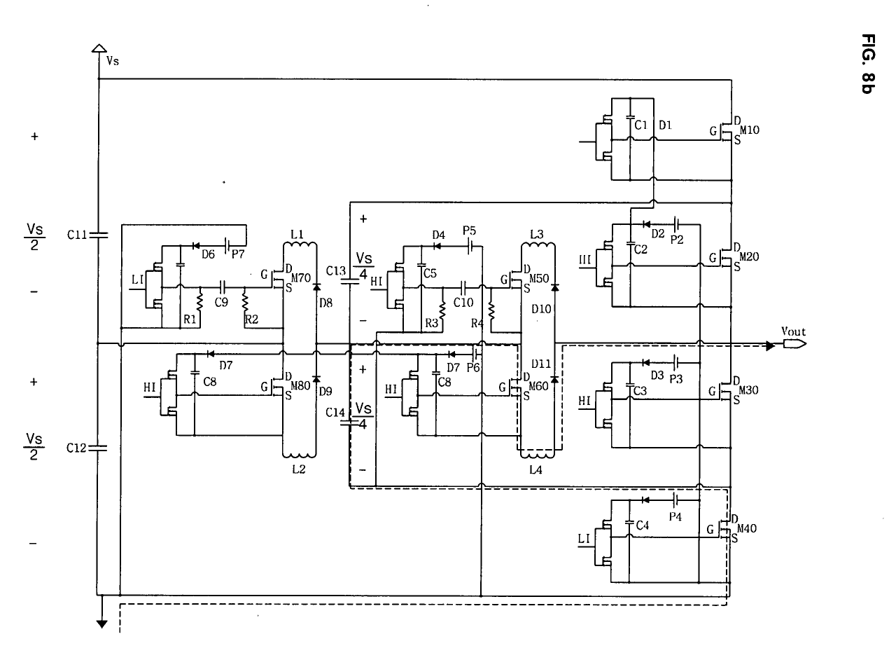

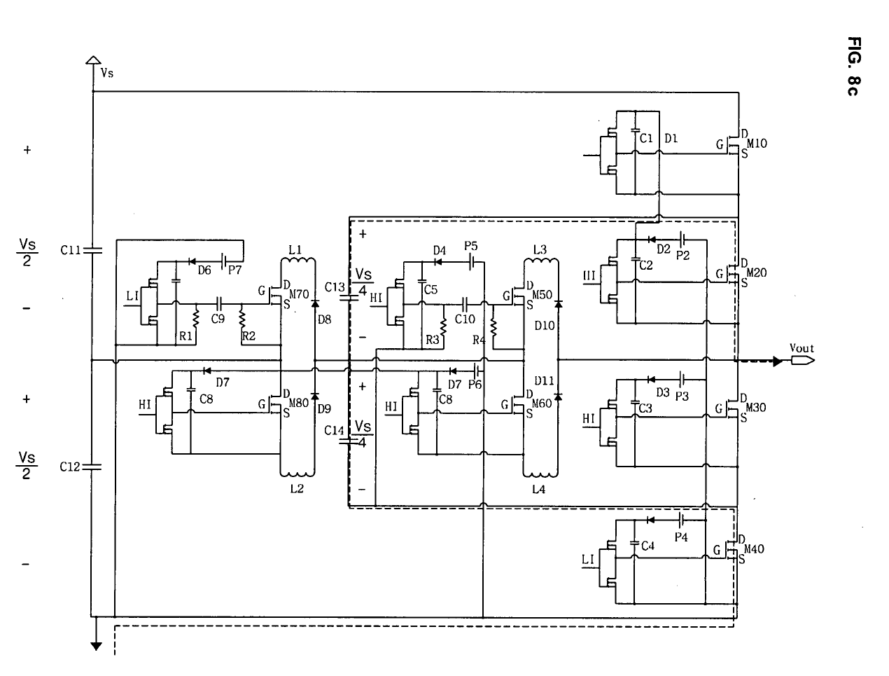

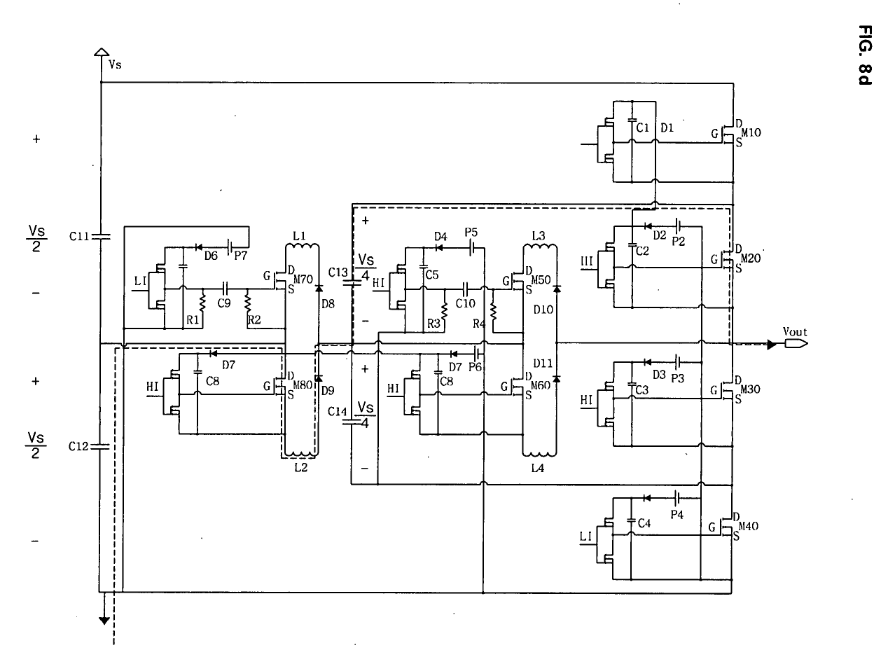

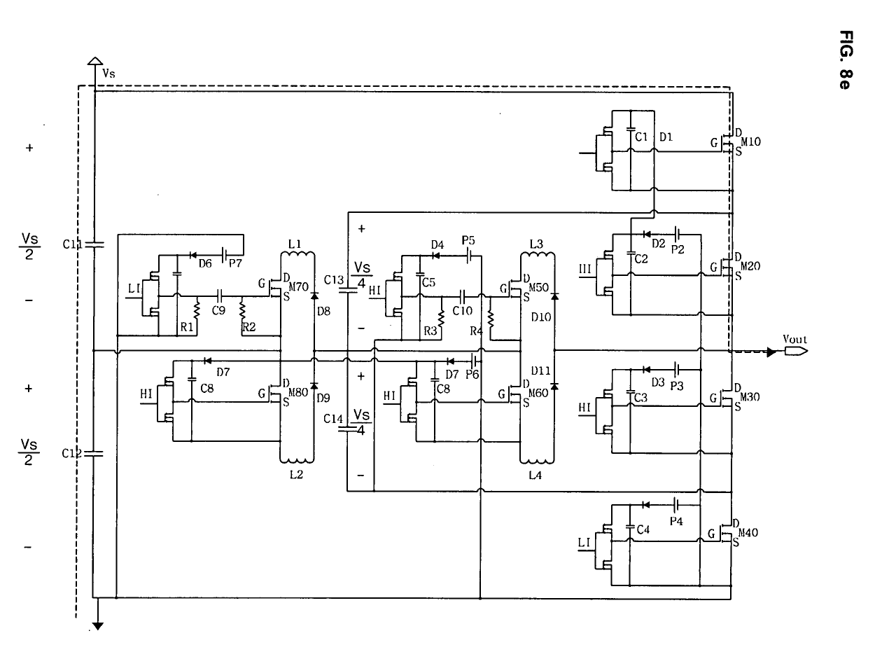

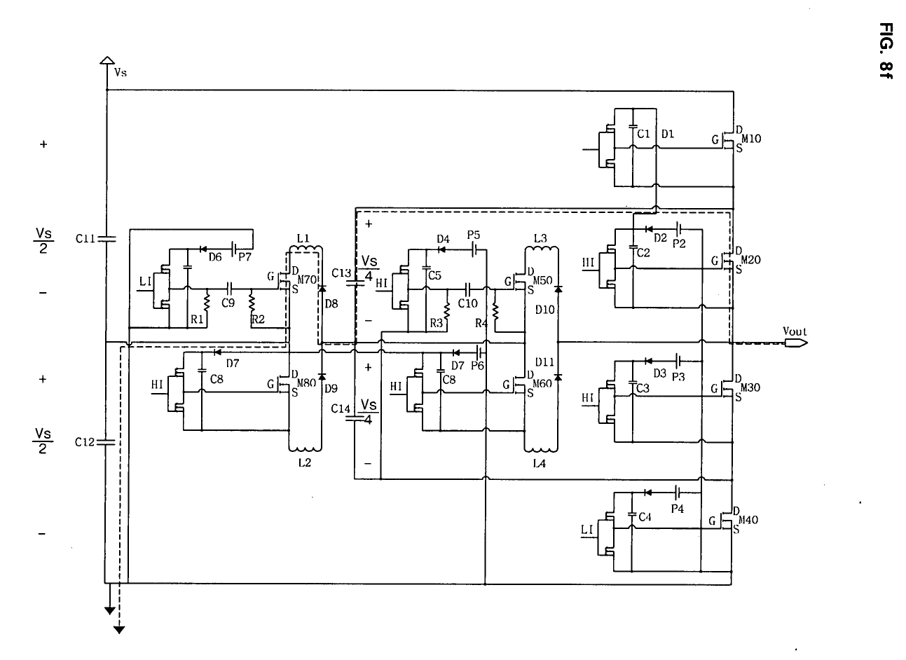

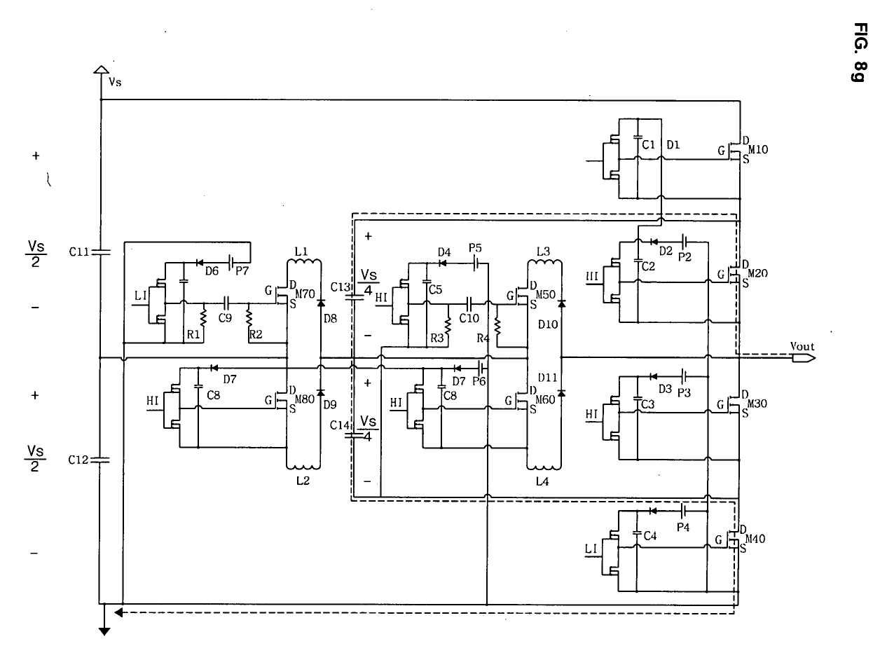

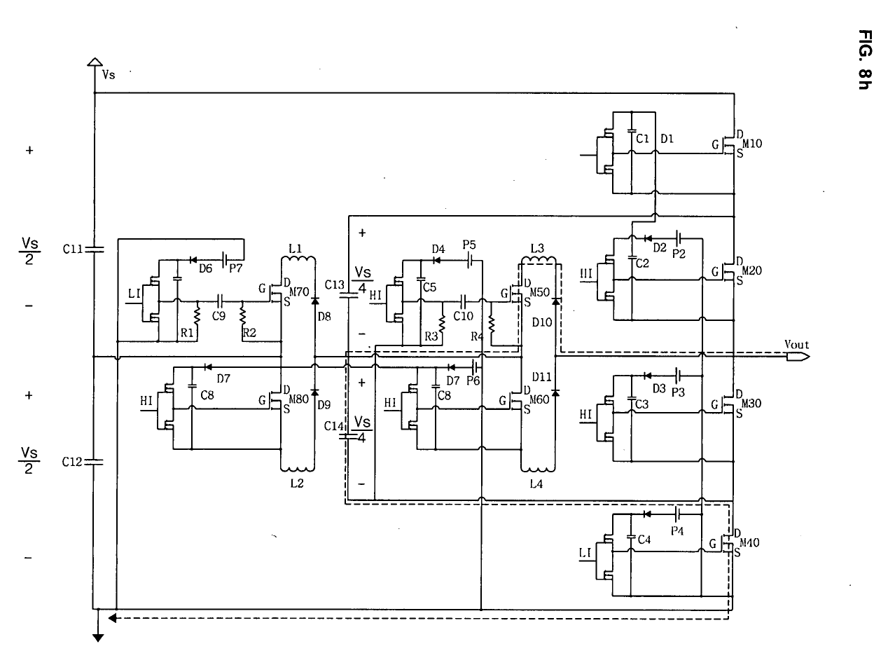

A method of operating the sustain driver 500 will be described in detail with reference to FIGS. 7 and 8A to 8H.

A first, second, third switching elements M10 to M80 are turned on if a voltage of a gate terminal is higher by 5 to 15V than that of a source terminal and are turned off if a voltage of the gate terminal is lower by 5 to 15V than that of the source terminal.

Gate drivers for controlling the first, second, third switching elements M10 to M80 by supplying a control signal comprise first gate drivers 510a, 510b, 510c, and 510d, second gate drivers 520a and 520b, and third gate drivers 530a and 530b.

The first gate drivers 510a, 510b, 510c, and 510d control the first switching elements M20, M30, M40, and M60, respectively depending on each control signal that receives through each of lines HI and LI.

The first gate drivers 510a, 510b, 510c, and 510d may comprise charge capacitors C2, C3, C4, and C6 for forming a driving voltage by charging a voltage that receives from driving voltage sources P2, P3, P4, and P6 and further comprise diodes D2, D3, and D5 so as to secure stability of a circuit operation.

A method of controlling the first switching elements M20, M30, M40, and M60 with the first gate drivers 510a, 510b, 510c, and 510d will be described using the first gate driver 510c as an implementation.

A diving voltage source P3 of the gate driver 510c supplies a constant voltage of 15V to the charge capacitor C3 through the diode D3, and a 15V driving voltage charged to the charge capacitor C3 controls the switching element M30 so that a upper switch or a lower switch of the line HI or LI is turned on depending on a control signal received through the line HI or LI.

If the upper switch of the line HI or LI is turned on depending on a control signal, the 15V driving voltage charged to the charge capacitor C3 is supplied to the gate terminal G of the switch M30.

Accordingly, a voltage difference between the gate terminal G and the source terminal S of the switch M30 becomes 15V, whereby the switch M30 is turned on.

If the lower switch of the line HI or LI is turned off depending on a control signal, a voltage difference is not generated between the gate terminal G and the source terminal S of the switch M30, whereby the switch M30 is turned off.

In this way, each of the first gate drivers controls so that each of the first switching elements is turned on or turned off.

The second gate drivers 520a and 520b controls the second switching elements M50 and M70, respectively.

The second gate drivers 520a and 520b comprise charge capacitors C7 and C5 that form a driving voltage by charging a voltage received from driving voltage sources P7 and P5, auxiliary charge capacitors C9 and C10 that receive and charge an auxiliary voltage for assisting a driving voltage from the outside of the second gate drivers 520a and 520b so that the second switching elements M50 and M70 drive by a driving voltage, and resistances R1, R2, R3, and R4 that are connected in series to each of both ends of the auxiliary charge capacitors C9 and C10.

The gate driver 520a will be described as an implementation. The resistance R2 whose one end is connected between one end of the auxiliary charge capacitor C9 and a gate terminal G of the second switching element M70 and whose the other end is connected in series to one end of the capacitor C12 of the sustain driver 500 performs a function of forming a 15V driving voltage in the gate terminal G and the source terminal S of the second switching element M50 so that the second switching element M50 is turned on. The resistance R1 whose one end is connected to the other end of the auxiliary charge capacitor C9 and whose the other end is connected to the other end of the capacitor C12 of the sustain driver 500 performs a function of securing stability of a circuit.

The reason why an auxiliary voltage is supplied to the second gate drivers is to be not driven with only a driving voltage charged to the charge capacitors C5 and C7 as source terminals of switching elements M5 and M7 are floated during driving even if a driving voltage is charged to the charge capacitors C5 and C7.

A voltage difference can be formed in the gate terminal and the source terminal of the switching elements M5 and M7 by supplying an auxiliary voltage and thus the switching elements M5 and M7 can be stably controlled.

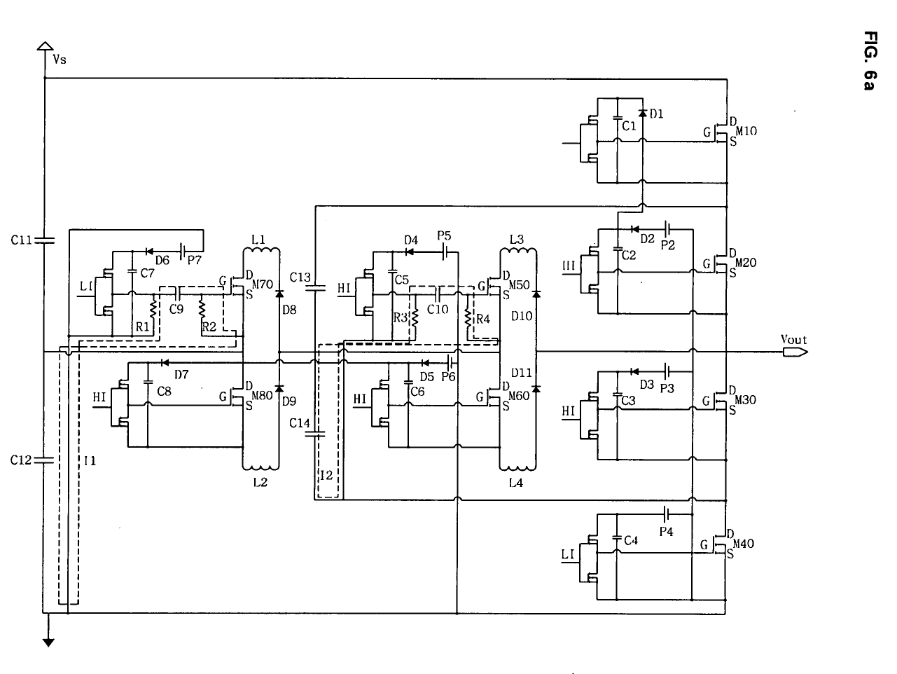

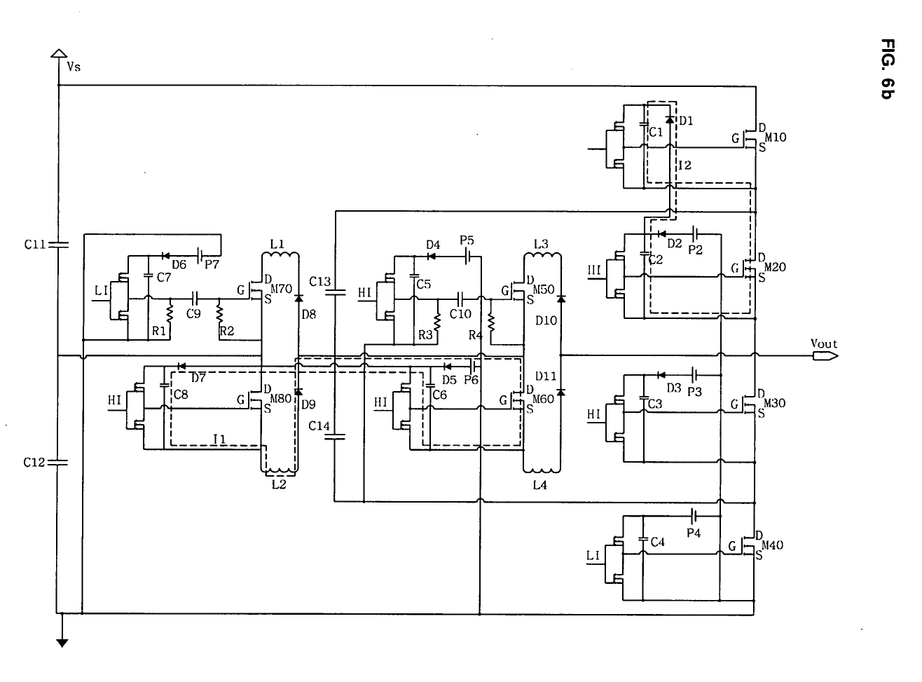

A method of driving the second gate drivers 520a and 520b will be described in detail with reference to FIG. 6A.

The third gate drivers 530a and 530b control the third switching elements M10 and M80, respectively.

Contrary to the first gate drivers 510a, 510b, 510c, and 510d or the second gate drivers 520a and 520b, the third gate drivers 530a and 530b do not comprise a driving voltage source but comprise charge capacitors C8 and C1 for forming a driving voltage of the third gate drivers 530a and 530b by charging a voltage received from other gate drivers and diodes D7 and D1 for intercepting a countercurrent.

Cathodes of the diodes D7 and D1 is electrically connected to the charge capacitors C8 and C1 of the third gate drivers 530a and 530b and anodes D7 and D1 of the diode is electrically connected to charge capacitors C6 and C2 of the first gate drivers 510a and 510b.

As the third gate drivers do not comprise a separate driving voltage source, a circuit becomes simple and a manufacturing cost reduces.

A method of driving the third gate drivers will be described in detail with reference to FIG. 6B.

FIG. 5 shows as an implementation that all of the first, second, and third gate drivers are comprised in a circuit, but only the first and second gate drivers may be used or only the first and third gate drivers may be used.

As a floating voltage source is not used in the second gate drivers 520a and 520b and the third gate drivers, an area and a bulk of a driver circuit can be reduced and as an expensive element for physically embodying the floating voltage source is not used, a manufacturing cost can be reduced.

Specifically, all circuits of the gate driver may not comprise only the first gate driver so as to control a switching element of a sustain driver for supplying a multi level of sustain signal.

In order to compose all circuits of the gate driver with only the first gate driver, driving voltage sources of the gate driver should be connected to the ground and a period when source terminals of all switching elements of the sustain driver has a ground level of voltage GND during driving is required. This is because switching elements that do not satisfy the above condition as in M1, M50, M70, and M80 are always comprised in a sustain driver for supplying a multi level of sustain signal.

Accordingly, in order to control switching elements such as M10, M50, M70, and M80, a sustain driver for supplying a multi level of sustain signal always requires a floating voltage source.

However, in order to physically embody the floating voltage source, an element using a relatively large bulk and area is essentially required and a circuit construction becomes more complicated, whereby a manufacturing cost increases.

However, as shown in FIG. 5, if the circuit is composed as in the second gate drivers and the third gate drivers, a bulk and an area of the circuit can be reduced and a circuit construction becomes also simpler than that of a gate driver using a floating voltage source.

Accordingly, a manufacturing cost of a plasma display apparatus is reduced.

FIG. 6A is a view illustrating a method of operating a second gate driver shown in FIG. 5.

As shown in FIG. 6A, as each of the second gate drivers 520a and 520b shown in FIG. 5 is connected to capacitors C12 and C14 of the sustain driver 500, an auxiliary voltage is supplied from the capacitors C12 and C14 of an external sustain driver 500 and the second gate drivers 520a and 520b.

Specifically, an auxiliary voltage can be formed by receiving a voltage from the capacitors C12 and C14 of the sustain driver 500 and charging the voltage to auxiliary charge capacitors C9 and C10 that is connected in series to the gate terminal G of the second switching elements M50 and M70.

A driving method of the second gate drivers 520a and 520b is as follows.

First, a gate driver 520a for controlling the switch M70 comprises a 15V driving voltage source, a charge capacitor C7, the auxiliary charge capacitor C9, and resistances R1 and R2.

Here, the 15V driving voltage is charged to the charge capacitor C7 through the diode D6 from the 15V driving voltage source P7 by a current pass (not shown) that is connected to P7(+), D6, C7, and P7(−).

As shown in the figure, an auxiliary voltage is charged from the C12 to the C9 through a first current pass that is connected to C2(+), R2, C9, R1, and C12(−).

Here, if a voltage of both ends that are charged to the C12 is referred to as “V1,” a voltage V1 is just charged to the C9.

Thereafter, if a control signal of turning on the switch M70 is supplied through the line HI of the gate driver 520a, the upper switch on the line HI is turned on.

If the upper switch on the line HI is turned on, a voltage of a node between the R1 and the C9 becomes 15V and the C9 just maintains the voltage V1, so that a voltage of a node between the C9 and the R2 becomes V1+15V. As a voltage of the C12(−) terminal is connected to the ground, a voltage of the C12(+) terminal becomes V1. Accordingly, a voltage of a node between the R2 and the C12(+) becomes V1.

Therefore, a voltage difference of 15V is generated in both ends of the R2 and a voltage difference between a gate terminal G and a source terminal S of the switch M70 is equal to that between both ends of the R2, whereby the switch M70 is turned on.

Next, a gate driver 520b for controlling the switch M50 comprises the 15V driving voltage source P5, the charge capacitor C5, the auxiliary charge capacitor C10, and resistances R3 and R4.

Here, as a current pass (not shown) that is connected to P5(+), D4, C5, M40, and P5(−) is formed when the switch M40 is turned on, 15V driving voltage is charged from the 15V driving voltage source P5 to the charge capacitor C5.

As shown in the figure, an auxiliary voltage is charged from C14 (−) to C1 through a second current pass that is connected to C14(+), R4, C10, R3, and C14.

If a control signal is supplied to the gate driver 520b after the 15V driving voltage and the auxiliary voltage are formed in the gate driver 520b, the switch M50 is turned on.

A method of turning on the switch M50 by the gate driver 520b is equal to a method of turning on the switch M70 by the gate driver 520a

FIG. 6B is a view illustrating a method of operating a third gate driver shown in FIG. 5.

As shown in FIG. 6B, the third gate drivers 530a and 530b receive a driving voltage for driving the third switching elements M10 and M80 from other gate drivers.

For example, the third gate drivers 530a and 530b can receive a driving voltage of the third gate drivers 530a and 530b from the first gate drivers 510a and 510b.

A driving method of the third gate drivers 530a and 530b is as follows.

First, the gate driver 530a for controlling the switch M80 comprises a charge capacitor C8 and a diode D7.

A cathode of the diode D7 is electrically connected to the charge capacitor C8 of the gate driver 530a and an anode of the diode D7 is electrically connected to the charge capacitor C6 of the gate driver 510a

First, if the switch M60 for controlling the gate driver 510a is turned on, the 15V driving voltage charged to the C6 is charged to the C8 by the first current pass that is connected to C6(+), D7, C8, 12, D9, M60, and C6(−).

If a control signal is supplied to a gate driver 530a via the line HI after the 15V driving voltage is formed in the gate driver 530a, the switch M50 is turned on.

Similarly to a case where the 15V driving voltage is formed in the gate driver 530a, in the gate driver 530b, a driving voltage is formed by receiving a voltage from the charge capacitor C2 to the charge capacitor C1 along the shown second current pass and the switch M10 is turned on depending on a control signal supplied to the line HI of the gate driver 503b.

If a driving voltage receives and uses from other gate drivers without providing a separate driving voltage source as in the third gate driver, it is not necessary to use a separate driving voltage source for driving the third gate driver, whereby a manufacturing cost can be reduced.

FIG. 7 is a view illustrating the output sustain signal and a switching timing chart of a sustain driver shown in FIG. 5.

FIGS. 8A to 8H are views illustrating a method of driving a sustain driver depending on switching timing shown in FIG. 7.

As shown in FIG. 7, the sustain driver 500 shown in FIG. 5 supplies a sustain signal comprising a half of a positive sustain voltage and a positive sustain voltage.

In this way, when a sustain signal rises from a ground level to a positive sustain voltage, the sustain signal does not rise at once but at two steps. Accordingly, withstand voltage characteristics of a switching element comprised in the sustain driver 500 can be lowered and thus a manufacturing cost can be reduced.

A driving method of the sustain driver 500 is as follows.

It is assumed that a Vs/2 voltage is charged to capacitors C11 and C12 of the shown sustain driver 500 and a Vs/4 voltage is charged to the capacitors C13 and C14. A voltage Vs means the same voltage as a positive sustain voltage of a sustain signal.

First, if the switches M30 and M40 are turned on in a t1 period of FIG. 7, a current pass that is connected to GND, M40, M30, and Vout is formed as in FIG. 8A and thus a ground level voltage of sustain signal is supplied to the electrode through the Vout.

Next, if the switches M40 and M60 are turned on in a period of FIG. 7, a current pass that is connected to GND, M40, C14, M60, L4, and Vout is formed as in FIG. 8B and thus a ground level voltage of a sustain signal rises up to a half Vs/2 of a positive sustain voltage by resonance between the inductor L4 and the panel.

Next, if the switches M20 and M40 are turned on in a t3 period of FIG. 7, a current pass that is connected to GND, M40, C14, C13, M20, and Vout is formed as in FIG. 8C and thus a sustain signal maintains a half Vs/2 of a positive sustain voltage during a predetermined time. Here, the predetermined time can be adjusted depending on a state of wall charges of an inner discharge cell in the plasma display panel and is adjusted depending on a time when the switches M20 and M40 are turned on.

Next, if the switches M80 and M20 are turned on in a t4 period of FIG. 7, a current pass that is connected to GND, M80, L2, D9, C13, M20, and Vout is formed as in FIG. 8D and thus a sustain signal rises from a half Vs/2 of a positive sustain voltage to a positive sustain voltage Vs. This is because a voltage value rises by a voltage Vs/2 from a voltage Vs/2 of the capacitor C12 by resonance between the inductor 12 and the capacitor C13.

Next, if the switches M10 and M20 are turned on in a t5 period of FIG. 7, a current pass that is connected to GND, C11, C12, M10, M20, and Vout is formed as in FIG. 8E and thus a sustain signal maintains a positive sustain voltage Vs and a sustain discharge is generated by a positive sustain voltage Vs within a discharge cell.

Next, if the switches M70 and M20 are turned on in a t6 period of FIG. 7, a current pass that is connected to Vout, M20, C13, D8, M70, C12, and GND is formed as in FIG. 8F and thus a sustain signal falls from a positive sustain voltage Vs to a half Vs/2 of a positive sustain voltage. This is because a voltage value in a positive sustain voltage falls by Vs/2 by resonance between the inductor LI and the capacitor C13.

Next, if the switches M20 and M40 are turned on in a t7 period of FIG. 7, a current pass that is connected to Vout, M20, C13, C14, M40, and GND is formed as in FIG. 8G and thus a sustain signal maintains a half Vs/2 of a positive sustain voltage by a voltage of the capacitor C13 and a voltage of the capacitor C14.

Next, if the switches M40 and M50 are turned on in a t8 period of FIG. 7, a current pass that is connected to Vout, D10, L3, M50, C14, M40, and GND is formed as in FIG. 8H and thus a sustain signal falls from a half of a sustain voltage to a ground level of voltage by resonance between the inductor L3 and the panel.

In this way, if a sustain signal does not rise at once from a ground level of voltage to a positive sustain voltage at once but rises from a ground level of voltage to a half of a positive sustain voltage and again rises from the half of a positive sustain voltage to a positive sustain voltage as in FIG. 7 and FIG. 8A to 8H, a switching element having low withstand voltage characteristics can be used in a sustain driver, whereby a manufacturing cost can be reduced.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel that comprises an electrode;
a sustain driver that supplies a sustain signal to the electrode and that comprises a first and second switching elements for supplying the sustain signal; and
a first and second gate drivers that drives each of the first and second switching elements,
wherein the first gate driver receives a driving voltage for driving the first switching element from a driving voltage source of the first gate driver,
the second gate driver comprises a driving voltage source that supplies a driving voltage for driving the second switching element, and
an auxiliary voltage for assisting the driving voltage is supplied from the outside of the second gate driver so that the second switching element is driven by the driving voltage.

2. The plasma display apparatus of claim 1, wherein the second gate driver receives the auxiliary voltage from a capacitor of the sustain driver.

3. The plasma display apparatus of claim 2, wherein the auxiliary voltage is formed by receiving a voltage from a capacitor of the sustain driver and charging the voltage to an auxiliary charge capacitor that is connected in series to a gate terminal of the second switching element.

4. The plasma display apparatus of claim 3, wherein each resistance is connected in series to both ends of the auxiliary charge capacitor and the each resistance is connected in series to the capacitor of the sustain driver.

5. The plasma display apparatus of claim 1, wherein the sustain driver supplies a signal rising from a first voltage to a second voltage through resonance and rising from the second voltage to a third voltage through resonance to the electrode.

6. The plasma display apparatus of claim 5, wherein the sustain driver supplies a sustain signal rising from the first voltage to the second voltage through resonance and then maintaining the second voltage during a predetermined period to the electrode.

7. The plasma display apparatus of claim 5, wherein the first voltage is substantially a ground level voltage GND.

8. The plasma display apparatus of claim 5, wherein the third voltage is substantially a sustain voltage.

9. The plasma display apparatus of claim 5, wherein the second voltage is substantially a half of a sustain voltage.

10. The plasma display apparatus of claim 1, wherein the electrode is a sustain electrode or a scan electrode.

11. A plasma display apparatus comprising:
a plasma display panel that comprises an electrode;
a sustain driver that supplies a sustain signal to the electrode and that comprises a first, second, and third switching elements for supplying the sustain signal; and
a first, second, and third gate drivers that drive each of the first, second, and third switching elements,
wherein the first gate driver receives a driving voltage for driving the first switching element from a driving voltage source of the first gate driver,
the second, gate driver comprises a driving voltage source that supplies a driving voltage for driving the second switching element and an auxiliary voltage for assisting the driving voltage is supplied from the outside of the second gate driver so that the second switching element is driven by the driving voltage, and
the third gate driver receives a driving voltage for driving the third switching element from other gate drivers.

12. The plasma display apparatus of claim 11, wherein the second gate driver receives an auxiliary voltage from a capacitor of the sustain driver.

13. The plasma display apparatus of claim 12, wherein the auxiliary voltage is formed by receiving a voltage from the capacitor of the sustain driver and charging the voltage to the auxiliary charge capacitor that is connected in series to a gate terminal of the second switching element.

14. The plasma display apparatus of claim 13, wherein each resistance is connected in series to both ends of the auxiliary charge capacitor and the each resistance is connected in series to the capacitor of the sustain driver.

15. The plasma display apparatus of claims 11, wherein the third gate driver receives a driving voltage of the third gate driver from the first gate driver.

16. The plasma display apparatus of claim 15, wherein the driving voltage is supplied from the first gate driver to the third gate driver while the first switching element is turned on.

17. The plasma display apparatus of claim 16, wherein the driving voltage is formed by receiving a voltage from a charge capacitor of the first gate driver and charging the voltage to a charge capacitor comprised in the third gate driver.

18. The plasma display apparatus of claim 17, further comprising a diode between the charge capacitor of the third gate driver and the charge capacitor of the first gate driver.

19. The plasma display apparatus of claim 18, wherein a cathode of the diode is electrically connected to the charge capacitor of the third gate driver and an anode of the diode is electrically connected to the charge capacitor of the first gate driver.

20. The plasma display apparatus of claim 11, wherein the sustain driver supplies a signal rising from a ground level of voltage to a half of a sustain voltage through resonance and rising from the half of the sustain voltage to a sustain voltage through resonance to the electrode.
